(19) United States
(12) Patent Application Publication
(10) Pub. No.: US 2011/0247848 A1
(43) Pub. Date: Oct. 13, 2011

(54) Hand-Held Power Tool

(75) Inventors: Kurt Sieber, Leinfelden-Echterdingen (DE); Otto Baumann, Leinfelden-Echterdingen (DE); Elisabeth Michl, Waldenbuch (DE); Hardy Schmid, Stuttgart (DE); Holger Ruebsaamen, Stuttgart (DE); Tobias Herr, Stuttgart (DE)

(73) Assignee: Robert Bosch GmbH, Stuttgart (DE)

(21) Appl. No.: 13/139,775

(22) PCT Filed: Oct. 16, 2009
(86) PCT No.: PCT/EP09/63524

§ 371 Date: Jun. 15, 2011

(30) Foreign Application Priority Data
Dec. 16, 2008 (DE) 102008054692.5

(51) Int. Cl. B25D 16/00

(52) U.S. Cl. 173/48

(57) ABSTRACT

A hand-held power tool, particularly a hammer drill, includes a work spindle, a hand-held power tool housing and an intermediate shaft, which is arranged in parallel to the work spindle and mounted in an axially displaceable manner for changing the operational mode, and a tooth sleeve, which is provided to transfer a torque to the intermediate shaft. The tooth sleeve is fixed in the axial direction by means of the hand-held power tool housing.

### PRIOR ART

The invention relates to a hand-held power tool according to the preamble of claim 1.

A hand-held power tool, in particular a hammer drill, having a work spindle, a hand-held power tool housing and an intermediate shaft that is arranged parallelwise in relation to the work spindle and mounted in an axially displaceable manner for a change of operating mode, and having a toothed sleeve provided to transmit a torque to the intermediate shaft, has already been proposed in DE 38 19 125 A1.

### DISCLOSURE OF THE INVENTION

The invention relates to a hand-held power tool, in particular a hammer drill, having a work spindle, a hand-held power tool housing and an intermediate shaft that is arranged parallelwise in relation to the work spindle and mounted in an axially displaceable manner for a change of operating mode, and having a toothed sleeve provided to transmit a torque to the intermediate shaft.

It is proposed that the toothed sleeve is fixed in the axial direction by means of the hand-held power tool housing. By a “work spindle” is also to be understood, in particular, a hammer tube in which an element provided for generating an impulse is guided. The work spindle is rotatable and in this case can be realized so as to be axially fixed and/or at least partially axially movable and/or of multiple parts. By a “change of operating mode” is to be understood, in particular, a switchover between two operating modes, in particular between an impact drilling operation, a drilling operation and/or a chiseling operation. By an “operating mode” are to be understood, in particular, the chiseling operation, the impact drilling operation and/or the drilling operation. In the case of a chiseling operation, a tool executes a motion along a main working direction. In the case of a drilling operation, the tool executes a rotary motion about a rotation axis, parallelwise in relation to the main working direction. In the case of an impact drilling operation, the tool executes the two motions simultaneously. By a “main working direction” is to be understood, in particular, a direction in which the hand-held power tool is normally moved during a working process, for example directly during a drilling process. By “provided” is to be understood, in particular, specially equipped and/or designed. By a “toothed sleeve” is to be understood, in particular, an element that at least partially surrounds a cavity and/or has at least one toothed element that preferably consists of teeth and tooth spaces and is realized as a spur gear, for transmitting a torque. By the term “transmit a torque” is also to be understood, in particular, transmission of a power by means of a rotary motion. By “fixed in the axial direction” is to be understood, in particular, immovable along an axis. In particular, in the case of a change of operating mode, the toothed sleeve remains unmoved in the axial direction in relation to a hand-held power tool housing and/or in relation to a motor shaft. By a “hand-held power tool” is to be understood in this connection, in particular, in addition to a hammer drill, also an impact drill and/or another hand-held power tool considered appropriate by persons skilled in the art. Owing to the design of the hand-held power tool according to the invention, the toothed sleeve fixed in the axial direction enables wearing of the toothed sleeve and/or of the motor shaft to be minimized in an effective manner and, advantageously, enables skewing of the toothed sleeve and/or of the motor shaft and/or of the intermediate shaft upon switching under load to be prevented.

Further, the hand-held power tool has a motor shaft, which is arranged parallelwise in relation to the work spindle. Advantageously, the toothed sleeve is fixed in the axial direction relative to the motor shaft. By “arranged parallelwise” is to be understood in this connection, in particular, that rotation axes of the work spindle, of the motor shaft and of the intermediate shaft are aligned parallelwise in relation to one another. Alternatively, the hand-held power tool can have a motor shaft that is arranged perpendicularly in relation to the work spindle. The motor shaft arranged parallelwise in relation to the work spindle enables an advantageous small structural height to be achieved.

Furthermore proposed is a switching element, which is axially displaceable relative to the toothed sleeve for at least one change of operating mode, whereby, advantageously, in the case of at least two operating modes such as, for example, in the case of a drilling operation and an impact drilling operation, a reliable and rotationally fixed connection between the intermediate shaft and the switching element is possible.

Further, the hand-held power tool has a coupling element, which connects at least the switching element and the toothed sleeve to one another in a rotationally fixed manner. By a “coupling element” is to be understood, in particular, a device that connects two elements to one another in a rotationally fixed manner irrespective of an axial displacement of the elements towards one another or away from one another.

Particularly advantageously, the coupling element is realized as a splined-shaft profile. Other realizations that are considered appropriate by persons skilled in the art and that perform a like function are also possible. Through the coupling element, advantageously, the switching element and the toothed sleeve are connected to one another, in all positions of the switching element and of the intermediate shaft, by a rotationally fixed connection.

In addition, it is proposed that the toothed sleeve at least partially surrounds the switching element. By “at least partially surround” is to be understood, in particular, that the switching element is arranged at least partially in the cavity surrounded by the toothed sleeve, whereby, advantageously, a required structural space can be reduced.

In a further development, a spring element is proposed, which is provided to displace at least the switching element at least in the case of a change of operating mode, whereby a simple design is possible. In particular, the spring element displaces the switching element in the case of a change from the drilling operation to the impact drilling operation. Instead of a spring element realized as a helical spring, another device considered appropriate by persons skilled in the art such as, for example, a rubber element, a hydraulic, magnetic or pneumatic device, can also be used to displace the switching element.

Furthermore proposed is a spring element that at least partially surrounds the toothed sleeve, whereby a particularly small amount of structural space is required for a transmission arrangement.

Further, a connecting element is proposed, which connects the intermediate shaft and the switching element to one another in a rotationally fixed manner in at least one operating mode. By a “connecting element” is to be understood, in particular, a device that, in at least one operating mode, prevents a rotatory relative motion of two elements, in this case the intermediate shaft and the switching element, in relation to one another. In particular, the connecting element prevents a rotatory relative motion of the two elements in relation to one another in a drilling operation and in an impact drilling operation. In at least one other operating mode, in particular in a chiseling operation, the connecting element renders possible a free running, i.e. a rotatory relative motion in which the two elements can be turned against one another. The first connecting element enables an advantageous rotary motion of the tool to be achieved during at least one operating mode.

In addition it is proposed that the connecting element is opened in the case of a chiseling operation. Advantageously, the connecting element that connects the intermediate shaft and the switching element to one another in a rotationally fixed manner in at least one operating mode is opened in the case of a chiseling operation. By “opened” it is to be understood in this connection, in particular, that the two elements connected by the connecting element are connected to one another in a rotationally fixed manner in the case of a drilling operation and an impact drilling operation and now have a free running in relation to one another. Advantageously, the opened connecting element enables an application range of the hand-held power tool to be extended.

Furthermore, a second connecting element is proposed, which, in at least one operating mode, transmits at least a torque from the switching element to a stroke generator, whereby an advantageous impact motion of the tool can be achieved. The stroke generator in this case can be realized, for example, by means of a wobble drive and/or an eccentric drive.

In a further development, it is proposed that the second connecting element is opened in the case of a drilling operation, whereby, advantageously, an application range of the hand-held power tool can be extended.

Further, an additional bearing element is proposed, by means of which at least the toothed sleeve is seated. By “additional bearing element” is to be understood, in particular, a bearing element that can be produced separately from elements that adjoin when in an integrated state, such as, in particular, a housing element and/or the toothed sleeve. Advantageously, the additional bearing element is realized as a stud. By the term “seated by means of the bearing element” is to be understood in this connection, in particular, that the bearing element diverts and/or supports linear forces occurring at least in the case of a seating. In this case, a bearing renders possible differently oriented motions, in this case a differing axial rotary motion of the toothed sleeve and of the bearing element. Various bearings considered appropriate by persons skilled in the art may be used, such as plain bearings, rolling bearings, sheet-metal cups, needle bearings and/or deep-groove ball bearings. The additional bearing element enables the toothed sleeve to be seated in a structurally simple manner.

In addition, it is proposed that the additional bearing element is at least connected to a housing element in a rotationally fixed manner, whereby the hand-held power tool is easily assembled.

In a further development, a journal is proposed, which is realized so as to be integral with a housing element and by means of which at least the toothed sleeve is seated. By “integral” in this connection is to be understood, in particular, that the journal and the housing element are produced from a common blank. An advantageous saving in components is thereby achieved.

Furthermore, a bearing is proposed, which seats at least the toothed sleeve in a stroke generator. By the term “seats in a stroke generator” is to be understood, in particular, that forces occurring in the case of a seating are diverted and/or supported by means of at least one component of the stroke generator, preferably a transmission element of the stroke generator. In particular, the bearing element is to seat the toothed sleeve in the stroke generator to which the second connecting element transmits a torque. Particularly advantageously, the seating of the toothed sleeve in the stroke generator enables structural space to be saved.

Further, at least one bearing is proposed, which is arranged within the toothed sleeve and which axially and/or radially seats the toothed sleeve. By “within the toothed sleeve” is to be understood, in particular, that the toothed sleeve at least partially surrounds the bearing. Additional structural space can be saved as a result of the bearing being within the toothed sleeve.

In a further development, it is proposed that the toothed sleeve has a journal. Advantageously, the journal is connected to the toothed sleeve in a rotationally fixed manner. The journal of the toothed sleeve enables a bearing to be arranged advantageously within the hand-held power tool housing.

### DRAWING

Further advantages are given by the following description of the drawing. Nine exemplary embodiments of the invention are represented in the drawings, three exemplary embodiments relating, in particular, to a device for transmitting a torque, and six exemplary embodiments relating to a seating of a toothed sleeve. The drawing, the description and the claims contain numerous features in combination. Expediently, persons skilled in the art will also consider the features individually and combine them into appropriate, further combinations. In particular, the exemplary embodiments one to three can be combined with the exemplary embodiments four to nine.

In the drawing:

FIG. 1 shows a schematic representation of a hand-held power tool realized as a hammer drill,

FIG. 2 shows a schematic inside view of the hand-held power tool from FIG. 1 in a first exemplary embodiment,

FIG. 3 shows a schematic inside view of the hand-held power tool in a second exemplary embodiment,

FIG. 4 shows a schematic inside view of the hand-held power tool in a third exemplary embodiment,

FIG. 5 shows a schematic detail view of a transmission arrangement of the hand-held power tool of the first exemplary embodiment,

FIG. 6 shows a schematic detail view of the transmission arrangement in a fourth exemplary embodiment,

FIG. 7 shows a schematic detail view of the transmission arrangement in a fifth exemplary embodiment,

FIG. 8 shows a schematic detail view of the transmission arrangement in a sixth exemplary embodiment,

FIG. 9 shows a schematic detail view of the transmission arrangement in a seventh exemplary embodiment, and

FIG. 10 shows a schematic detail view of the transmission arrangement in an eighth exemplary embodiment.

### DESCRIPTION OF THE EXEMPLARY EMBODIMENTS

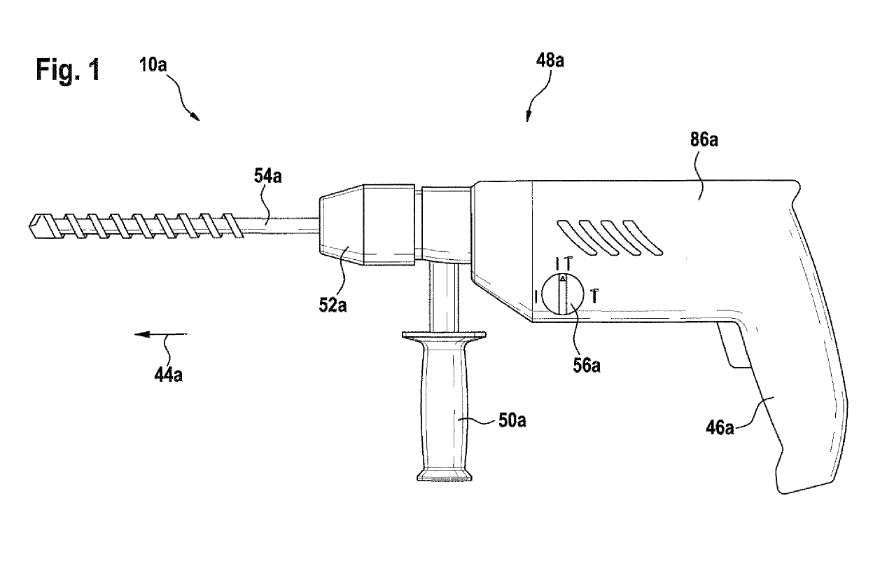

FIG. 1 shows a schematic representation of a first exemplary embodiment of a hand-held power tool 10a, realized as a hammer drill, having a pistol-shaped hand-held power tool housing 86a. The hand-held power tool 10a has a main handle 46a, which is angled in relation to a main working direction 44a and which is realized so as to be integral with the hand-held power tool housing 86a. In a front region 48a of the hand-held power tool 10a there is an additional handle 50a, a tool chuck 52a, a tool 54a realized as an SDS-plus drilling chisel, and an operating element 56a. An operator, not represented in greater detail, can effect a change of operating mode by means of the operating element 56a.

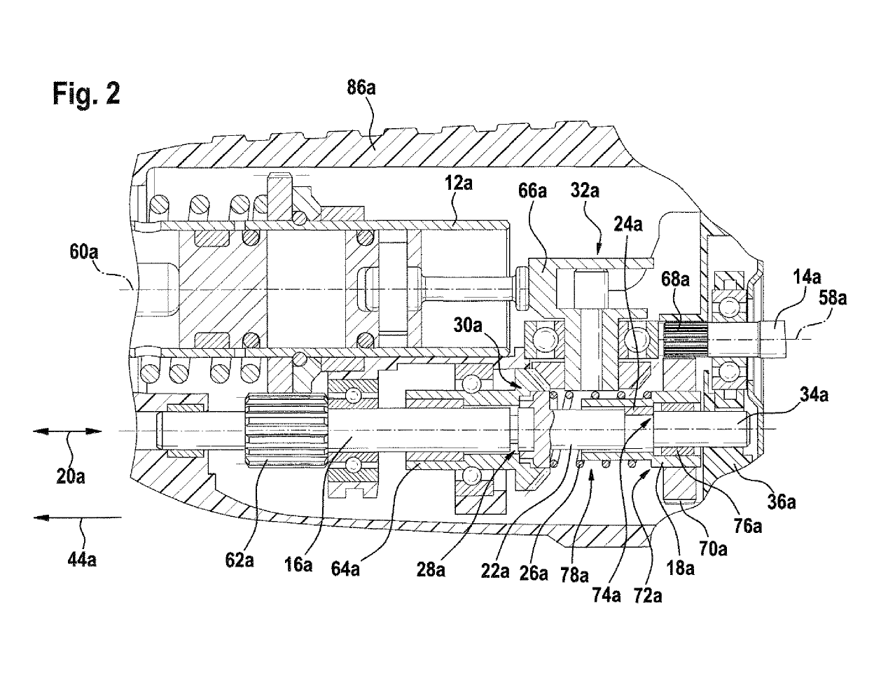

Shown in FIG. 2 is a schematic representation of an inside view of a transmission arrangement 57a of the hand-held power tool 10a, which is provided to change the operating mode of the hand-held power tool 10a. The hand-held power tool 10a has a motor shaft 14a, which can be driven by a motor, not represented in greater detail, and a work spindle 12a. A rotation axis 58a of the motor shaft 14a extends parallelwise in relation to the main working direction 44a and parallelwise in relation to a rotation axis 60a of the work spindle 12a. An impulse-generating device, which is represented only partially and which has a stroke generator 32a, is accommodated in the work spindle 12a and in front of and behind the work spindle 12a in the main working direction 44a. Further, the hand-held power tool 10a has an intermediate shaft 16a arranged parallelwise in relation to the work spindle 12a. The intermediate shaft 16a is disposed in an axially displaceable manner for a change of operating mode by means of the operating element 56a, and has an outer toothing 62a, which, in at least one operating mode, transmits a torque to the work spindle 12a, which is realized as a hammer tube. Furthermore, the hand-held power tool 10a has a toothed sleeve 18a, which transmits a torque from the motor shaft 14a to a switching element 22a during an operation.

The toothed sleeve 18a is fixed in an axial direction 20a relative to the motor shaft 14a by means of the hand-held power tool housing 86a. For a change of operating mode, the hand-held power tool 10a has the switching element 22a, which is axially displaceable relative to the toothed sleeve 18a for a change of operating mode. A transmission of the torque from the toothed sleeve 18a to the switching element 22a is effected by means of a coupling element 24a, which is realized as a splined-shaft profile and which connects the switching element 22a and the toothed sleeve 18a to one another in a rotationally fixed manner.

In addition, the hand-held power tool 10a has the stroke generator 32a, having a transmission element 64a and having an eccentric gear 66a, and has a spring element 26a. At an end lying in the main working direction 44a, the motor shaft 14a has a toothing 68a that, together with the toothing 70a of the toothed sleeve 18a, constitutes a spur gear transmission. The toothed sleeve 18a is realized as a hollow shaft, which has three outer radii that become smaller along the main working directions 44a, and two inner radii that become smaller in a radial direction along the main working directions 44a. The toothing 70a is arranged in the region of the largest outer radius, which is constituted by a ring pressed onto the toothed sleeve 18a. A transition 72a between the middle and the small outer radius to a support serves, in the axial direction, as a bearing contact surface for the spring element 26a. A transition 74a between the large and the small inner radius serves as a bearing contact surface for a bearing 76a. The bearing 76a seats the toothed sleeve 18a in a housing element 36a, which is indirectly connected to the hand-held power tool housing 86a via the bearing element 34a. The toothed sleeve 18a surrounds the switching element 22a in a region 78a, which lies in the main working direction 44a and extends in the form of a tube, parallelwise in relation to the main working direction 44a.

In the case of a change of operating mode between drilling operation and impact drilling operation, the spring element 26a displaces the switching element 22a, and is realized as a helical spring. For this purpose, the spring element 26a bears on the toothed sleeve 18a and on the switching element 22a, and presses the two elements 18a, 22a apart from one another in an axial direction. Further, during the chiseling operation and the impact drilling operation, the spring element 26a presses the switching element 22a against the transmission element 64a of the stroke generator 32a, and thereby enables a rotationally fixed connection between the switching element 22a and the transmission element 64a. The spring element 26a surrounds the toothed sleeve 18a and the switching element 22a, partially in each case, in a region that extends, in the form of a tube, parallelwise in relation to the main working direction 44a.

The hand-held power tool 10a has a first connecting element 28a, which, in the case of a drilling operation and an impact drilling operation, connects the intermediate shaft 16a and the switching element 22a to one another in a rotationally fixed manner. The first connecting element 28a is realized as a spline. In the case of a chiseling operation, the intermediate shaft 16a is displaced axially in the main working direction 44a by means of the operating element 56a. As a result, the first connecting element 28a opens, in that the intermediate shaft 16a is moved away from the switching element 22a, and no torque is transmitted to the intermediate shaft 16a, and consequently to the work spindle 12a and the tool 54a.

The hand-held power tool 10a has a second connecting element 30a, which, in the case of a chiseling operation and an impact drilling operation, connects the switching element 22a and the transmission element 64a of the stroke generator 32a to one another in a rotationally fixed manner. The second connecting element 30a is realized as a spline, which is arranged on the switching element 22a, on an outer radius in the main working direction 44a. In the case of a drilling operation, the intermediate shaft 16a is displaced axially contrary to the main working direction 44a, by means of the operating element 56a. As a result, the intermediate shaft 16a likewise displaces the switching element 22a contrary to the main working direction 44a, against a spring pressure of the spring element 26a. As a result, the second connecting element 30a opens. No torque is transmitted to the transmission element 64a and, consequently, to the stroke generator 32a.

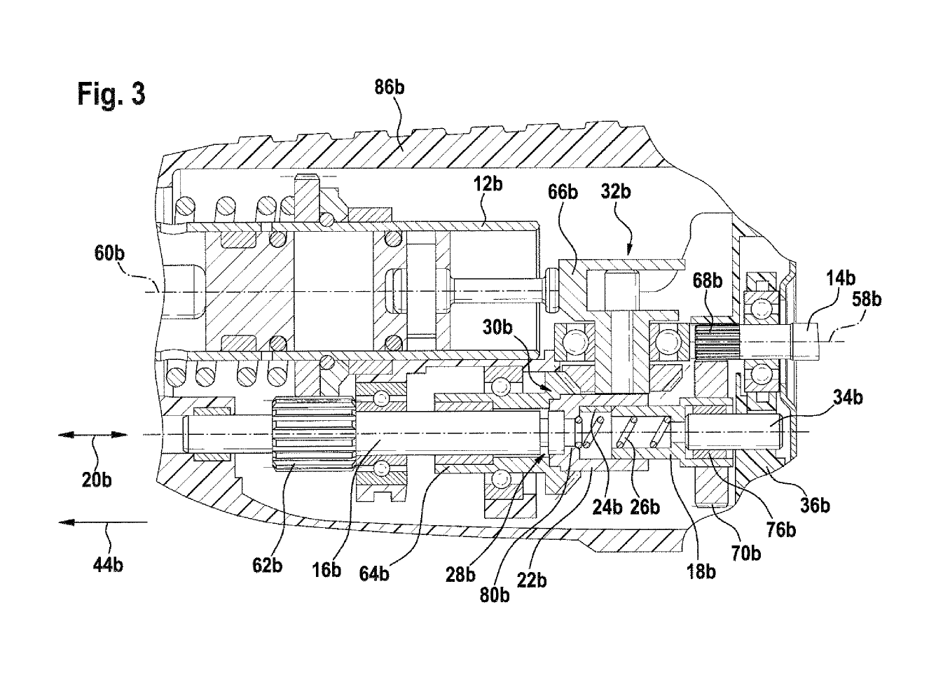

Further exemplary embodiments of the invention are shown in FIGS. 3, 4 and 6 to 10. To distinguish the exemplary embodiments, the letter a in the references of the exemplary embodiment in FIGS. 1, 2 and 5 is replaced by the letters b to h in the references of the exemplary embodiments in FIGS. 3, 4 and 6 to 10. The following descriptions are limited substantially to the differences between the exemplary embodiments, and reference may be made to the description of the other exemplary embodiments, in particular in FIGS. 1, 2 and 5, in respect of components, features and functions that remain the same.

FIG. 3 shows a hand-held power tool 10b, in which, unlike the first exemplary embodiment in FIG. 2, a spring element 26b and a toothed sleeve 18b are arranged partially within a switching element 22b. The switching element 22b in this case partially surrounds the toothed sleeve 18b. In this case, the spring element 26b is arranged within the toothed sleeve 18b and the switching element 22b. Webs 80b arranged within the toothed sleeve 18b and within the switching element 22b serve as bearing contact surfaces for the spring element 26b.

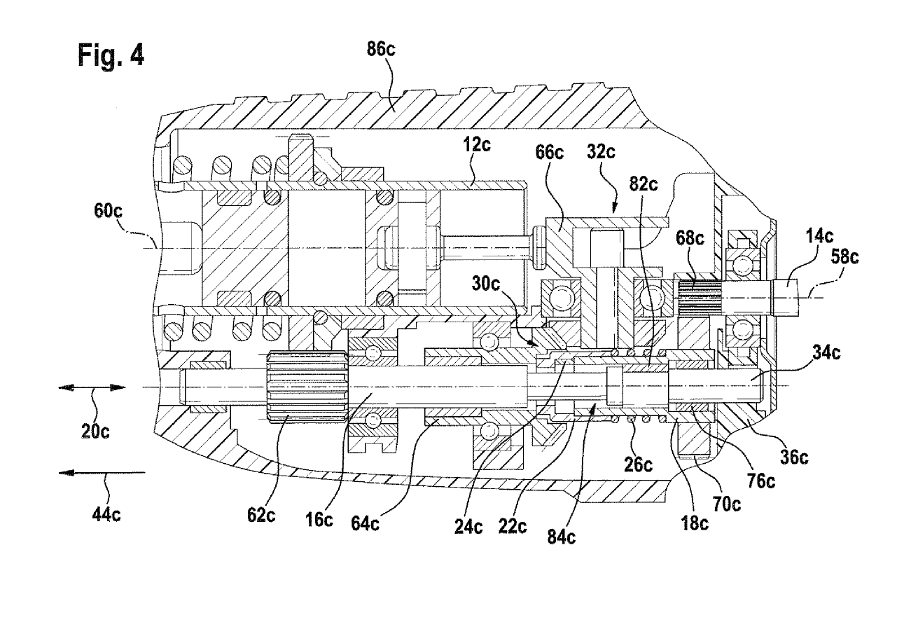

Furthermore, FIG. 4 shows a hand-held power tool 10c, in which, unlike the first exemplary embodiment in FIG. 2, a first connecting element 82c connects a toothed sleeve 18c and an intermediate shaft 16c in a rotationally fixed manner in the case of a drilling operation or an impact drilling operation. The first connecting element 82c is realized as a splined-shaft profile and arranged within the toothed sleeve 18c. In this case, a switching element 22c is arranged coaxially in relation to the intermediate shaft 16c. The switching element 22c partially surrounds the toothed sleeve 18c in a region extending, in the form of a tube, parallelwise in relation to the main working direction 44a. In the case of a drilling operation and an impact drilling operation, the intermediate shaft 16c engages in the splined-shaft profile of the toothed sleeve 18c. In the case of a chiseling operation, the intermediate shaft 16c is displaced, and moves in a region 84c of the toothed sleeve 18c that has no splined shaft. In this case, no torque is transmitted from the toothed sleeve 18c to the intermediate shaft 16c.

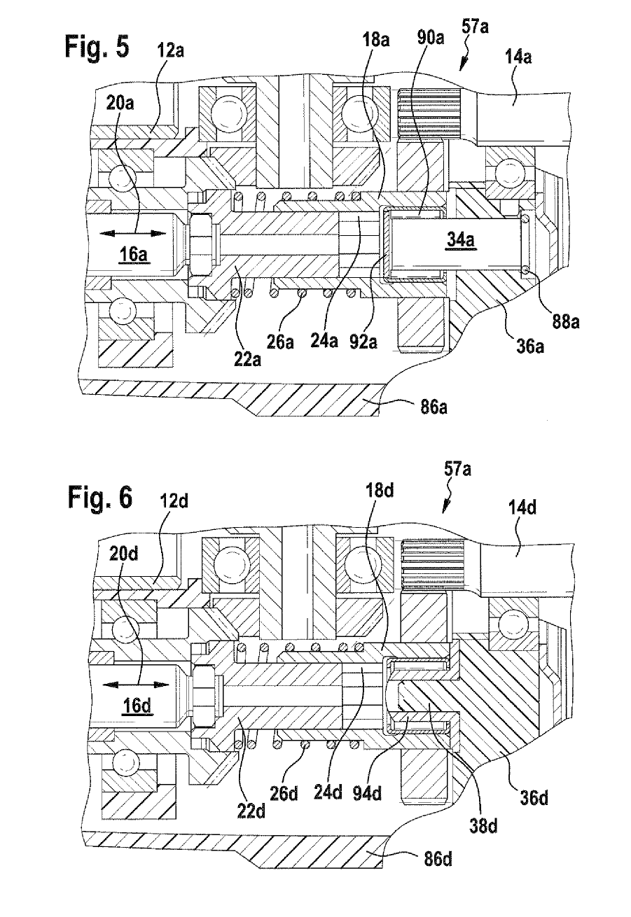

FIG. 5 shows a detail representation of the seating of the toothed sleeve 18a of the first exemplary embodiment from FIG. 2. For the purpose of seating the toothed sleeve 18a, the transmission arrangement 57a has the additional bearing element 34a, which is realized as a stud. The bearing element 34a is pressed into the housing element 36a, which is realized as an intermediate flange, and is thereby connected to the hand-held power tool housing 86a. Axially, the bearing element 34a is secured by means of a snap ring 88a.

For the purpose of radially seating the toothed sleeve 18a, the transmission arrangement 57a has a needle bearing 90a, which is arranged coaxially in relation to the toothed sleeve 18a, between the bearing element 34a and the toothed sleeve 18a. Axially, the toothed sleeve 18a is seated by means of a washer 92a inserted in the toothed sleeve 18a. The needle bearing 90a and the washer 92a can be realized in an integral manner.

Further, FIG. 6 shows an alternative seating of a toothed sleeve 18d. In this case, a journal 38d is provided instead of a stud as in FIG. 5. The journal 38d is made from light metal, realized so as to be integral with a housing element 36d, and is thus connected to a hand-held power tool housing 86d. An axial and radial seating is effected by means of an integral sheet-metal cup 94d, which extends axially along the journal 38d and radially along the housing element 36d. Alternatively, it is possible for the sheet-metal cup 94d to be realized in multiple parts, as a sleeve and as a washer.

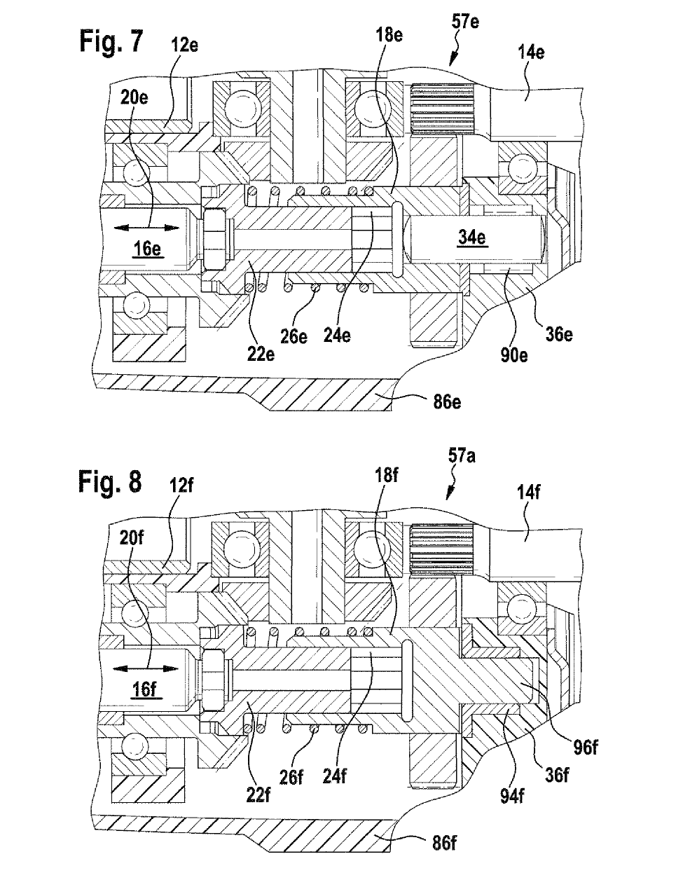

In an exemplary embodiment shown in FIG. 7, a bearing element 34e realized as a stud is pressed into a toothed sleeve 18e. For the purpose of radial seating, a transmission arrangement 57e has a needle bearing 90e, which is arranged between the bearing element 34e and a housing element 36e that is realized as an intermediate flange and connected to a hand-held power tool housing 86e.

Furthermore, FIG. 8 shows an exemplary embodiment in which a journal 96f is formed onto a toothed sleeve 18f. The journal 96f and the toothed sleeve 18f are thus realized in an integral manner. An axial and radial seating is effected by means of a sheet-metal cup 94f, which extends axially along the journal 96f and radially along the housing element 36f, which is connected to a hand-held power tool housing 86f.

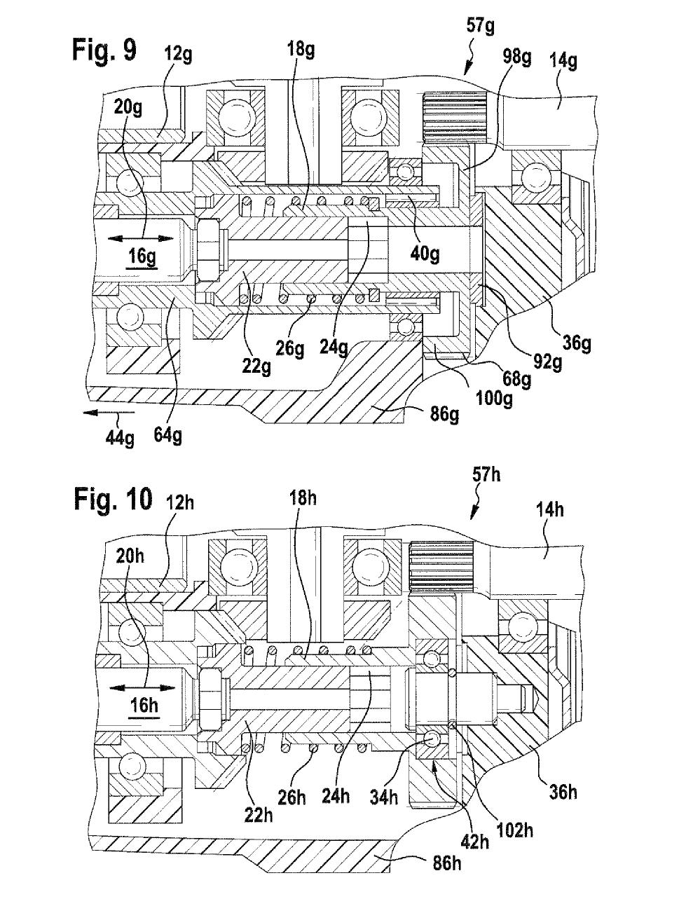

A further exemplary embodiment is shown by FIG. 9. In the case of the exemplary embodiment, a toothed sleeve 18g has, on a side that is contrary to the main working direction 44g, an extension 98g that extends in the radial direction and that includes an offset portion 100g in the main working direction 44g. The offset portion 100g has a toothing 68g, which is meshed with a motor shaft 14g. By means of a bearing 40g that is realized as a plain bearing, the toothed sleeve 18g is seated in a transmission element 64g of a stroke generator 32g, which is realized as a wobble bearing. Axially, the toothed sleeve 18g is seated against a housing element 36g, and thus against a hand-held power tool housing 86g, by means of a washer 92g.

FIG. 10 shows a bearing 42h, which is arranged within a toothed sleeve 18h and pressed into the toothed sleeve 18h, and which is realized as a deep-groove ball bearing. The bearing 42h is fixed axially with a retaining ring 102h on an additional bearing element 34h that is realized as a shoulder screw, and is thereby seated against a housing element 36h and a hand-held power tool housing 86h.

1. A hand-held power tool, in particular a hammer drill, comprising:
a work spindle;
a hand-held power tool housing; and
an intermediate shaft that is arranged parallelwise in relation to the work spindle and mounted in an axially displaceable manner for a change of operating mode, and having a toothed sleeve provided to transmit a torque to the intermediate shaft,
wherein the toothed sleeve is fixed in the axial direction by means of the hand-held power tool housing.

2. The hand-held power tool as claimed in claim 1, further comprising a motor shaft arranged parallelwise in relation to the work spindle.

3. The hand-held power tool as claimed in claim 1, further comprising a switching element, which is axially displaceable relative to the toothed sleeve for at least one change of operating mode.

4. The hand-held power tool as claimed in claim 3, further comprising a coupling element, which connects at least the switching element and the toothed sleeve to one another in a rotationally fixed manner.

5. The hand-held power tool at least as claimed in claim 3, wherein the toothed sleeve at least partially surrounds the switching element.

6. The hand-held power tool as claimed in claim 3, further comprising a spring element, which is provided to displace at least the switching element at least in the case of a change of operating mode.

7. The hand-held power tool as claimed in claim 1, further comprising a spring element that at least partially surrounds the toothed sleeve.

8. The hand-held power tool as claimed in claim 3, further comprising a connecting element, which connects the intermediate shaft and the switching element to one another in a rotationally fixed manner in at least one operating mode.

9. The hand-held power tool as claimed in claim 1, wherein a connecting element is opened in the case of a chiseling operation.

10. The hand-held power tool as claimed in claim 3, further comprising a connecting element, which, in at least one operating mode, transmits at least a torque from the switching element to a stroke generator.

11. The hand-held power tool as claimed in claim 1, further comprising an additional bearing element, by means of which at least the toothed sleeve is seated.

12. The hand-held power tool as claimed in claim 11, wherein the additional bearing element is at least connected to a housing element in a rotationally fixed manner.

13. The hand-held power tool as claimed in claim 1, further comprising a journal, which is realized so as to be integral with a housing element and by means of which at least the toothed sleeve is seated.

14. The hand-held power tool as claimed in claim 1, further comprising a bearing, which seats at least the toothed sleeve in a stroke generator.

15. The hand-held power tool as claimed in claim 1, wherein the toothed sleeve has a journal.
